(19) United States
(12) Patent Application Publication
(10) Pub. No.: US 2015/0193839 A1
(43) Pub. Date: Jul. 9, 2015

(54) METHOD AND SYSTEM FOR DONATING TO THIRD-PARTY BENEFICIARIES

(71) Applicants: Richard Masino, St. James, NY (US); Jesse Porter, Denver, CO (US); Thomas Miller, Denver, CO (US)

(72) Inventors: Richard Masino, St. James, NY (US); Jesse Porter, Denver, CO (US); Thomas Miller, Denver, CO (US)

(21) Appl. No.: 14/592,647

(22) Filed: Jan. 8, 2015

Related U.S. Application Data
(60) Provisional application No. 61/924,713, filed on Jan. 8, 2014.

(51) Int. Cl. G06Q 30/02; G06Q 40/00

(52) U.S. Cl. CPC G06Q 30/0279; G06Q 40/00

(57) ABSTRACT

The present invention relates to a network based, third-party beneficiary donation system, and in particular to systems and methods that allow a merchant to provide a choice to participating consumer(s) in the form of donations to third party beneficiaries based on consumer purchases wherein the consumer chooses their third party beneficiary from a merchant curated list or customer self-generated list and independently determines the percentage amount of the donation or selects a pre-determined amount. In this manner, consumers are provided with an option to purchase products from the authorized merchant knowing that the product purchases may result in a specified donation to a customer selected third-party beneficiary or multiple customer selected third party beneficiaries on a per product or per order basis. Third party beneficiaries are generally intended to be charities or causes but are not required to have tax-exempt status.

### CROSS-REFERENCE TO RELATED APPLICATION

The present disclosure claims priority to U.S. Provisional Patent Application Ser. No. 61/924,713, filed on Jan. 8, 2014, entitled “System and Method for Donating to Third-Party Beneficiaries”, the entirety of which is incorporated herein by reference.

### TECHNICAL FIELD

The present invention relates generally to systems and methods for providing a third-party beneficiary donation/giving program, and more particularly to systems and methods for operating a third-party beneficiary donation program that benefits third-party beneficiaries resulting from the purchase of products bought by participating supporters of a third-party beneficiary donation program and/or customers of the merchant.

### BACKGROUND ART

Merchants often use techniques to prompt consumers into making a particular purchase. These techniques are commonly in the form of monetary incentives, relying on the principle that a lower price will result in increased sales. Merchants may employ these techniques, for example, to help clear inventory before new merchandise is released, to ease the release of a new product, to increase sales near the end of the fiscal year, to compete with a competitor over particular products, or to generally spur sales. Monetary incentives may come in the form of a “sale” (i.e., temporary reduction in price at the register or eCommerce site), a discount coupon, a mail-in rebate (i.e., a refund of part or the entire purchase price which is received by mail or email), or a store credit (i.e., credit that may be applied to another store purchase).

Although consumers typically are offered to make purchases by a form of price reduction, non-monetary reasons also motivate consumers to make purchases with a merchant. For instance, the charitable actions by and intentions of a merchant may demonstrate to a consumer that the merchant is a force for good such that the consumer is non-monetarily incented to do business with the merchant who the consumer deems worthy of such support. As such, it would be an advance in the relevant arts to develop non-monetary incentive methodologies that will motivate a consumer to conduct a transaction with a merchant.

### SUMMARY OF THE INVENTION

The present invention relates to a manual and/or automated, network based, third-party beneficiary donation system, program and associated method, and in particular to systems and methods that allow the merchant/patent owner and/or other licensed merchants (herein referred to collectively as “authorized merchant(s)”) to provide a choice to participating consumer(s) or customer(s) in the form of donations to third party beneficiaries based on consumer purchases wherein the consumer chooses their third party beneficiary from a merchant curated list or customer self-generated list and independently determines the percentage amount or absolute dollar/cents amount of the donation or selects a pre-determined amount expressed as either a percentage or absolute dollar/cents amount. In this manner, consumers are provided with an option to purchase products from the authorized merchant(s) knowing that the product purchases may result in a specified donation to a customer selected third-party beneficiary or multiple customer selected third party beneficiaries on a per product or per order basis. Third party beneficiaries are generally intended to be charities or causes (herein used synonymously) but are not required to have tax-exempt status.

The present invention is also directed to a coupon, coupon/code, promotion/promotional code, discount/discount code, sale/sale code or couponing/platform (herein referred to collectively as a coupon or couponing platform) that attaches amounts of charitable donations linked to discounts of the products being purchased. This is unique from traditional coupons that one dimensionally discounts the purchase price of a product to the consumer. Additionally, the use of the coupon or couponing/platform enables the customer to have multiple choices in regards to the use of a coupon. The customer may either take a full amount of the coupon as a discount to purchase price or forgo the personal discount benefit entirely and assert a directive to the authorized merchant to give the equivalent amount to one or more charities or causes of the consumers or authorized merchants choice as a donation or monetary support, or the consumer may choose to take a portion of the coupon value as a discount to purchase price and issue a directive for the other portion be given to one or more customer selected charities or causes.

### DESCRIPTION OF THE DRAWINGS

In the accompanying drawings:

FIG. 1 is a captured screenshot illustrating a graphical view of a merchant website offering items for purchase and choices available to a consumer for donating to one or more third party beneficiaries in accordance with one embodiment of the method of the present invention;

FIG. 2 is a captured screenshot illustrating a graphical view of how the website shown in FIG. 1 works for donating to third party beneficiaries to be recipients of funds as chosen by the customer;

FIG. 3 is a website screenshot illustrating a graphical view of a customer check out experience depicting a product purchased with a charitable organization selected by a consumer;

FIG. 4 is a captured screenshot illustrating a graphical view of the consumers ability to choose different third party beneficiaries to be recipients of funds as chosen by the consumer;

FIG. 5 is a flowchart illustrating the steps of donating to a third party beneficiary(s) in accordance with one embodiment of the method of the present invention;

FIG. 6 is a continuation of the flowchart shown in FIG. 5 illustrating the steps of donating to a third party beneficiary(s) in accordance with one embodiment of the method of the present invention; and

FIG. 7 is a graphical illustration of a coupon which may be delivered electronically or physically for donating to a third party beneficiary(s) in accordance with one embodiment of the method of the present invention.

### DESCRIPTION OF EMBODIMENTS

In the following discussion, numerous specific details are set forth to provide a thorough understanding of the present invention. However, those skilled in the art will appreciate that, unless indicated otherwise, all functions described herein may be performed in either hardware or software (electronic), or some combination thereof or in a manual, non-computerized way. In a preferred embodiment, however, the functions are performed by a processor, such as a computer or an electronic data processor, in accordance with code, such as computer program code, software, and/or integrated circuits that are coded to perform such functions, unless indicated otherwise. While the exemplary embodiments illustrated herein may show the various embodiments of the invention (or portions thereof) collocated, it is to be appreciated that the various components of the various embodiments may be located at distant portions of a distributed network, such as a local area network, a wide area network, a telecommunications network, social network, an intranet and/or the Internet, or within a dedicated object handling system.

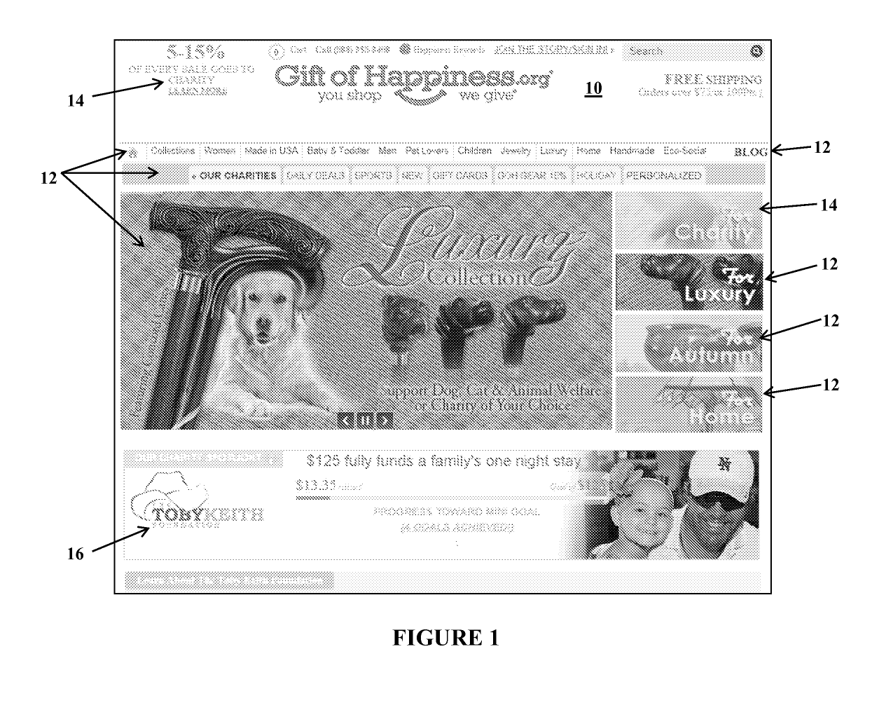

Referring now to FIG. 1, there is shown a captured screen shot 10 of a website that provides a methods and system for allowing a merchant or authorized merchandising participants to provide rewards 14 to participating consumers in the form of donations 14 to third party beneficiaries based on consumer purchases of products 12 offered by the authorized merchants. Turning once again to FIG. 1, in one embodiment, the designated items comprise digital and/or physical goods and/or services 12. In another embodiment, the third-party beneficiaries may comprise nonprofit organizations 16 which by way of example and not of limitation may be causes for the benefit of people, animals and the environment other charitable endeavors and fundraisers such as Little Leagues, Schools, Churches and anything that some person or entity may want to raise money for and the like as well as causes-related organizations or individuals that want to raise money for any reason which may include those for their self-interest such as for example to pay for a wedding or to launch a business idea, pay the bills including those 16 that are not recognized as tax-exempt organizations.

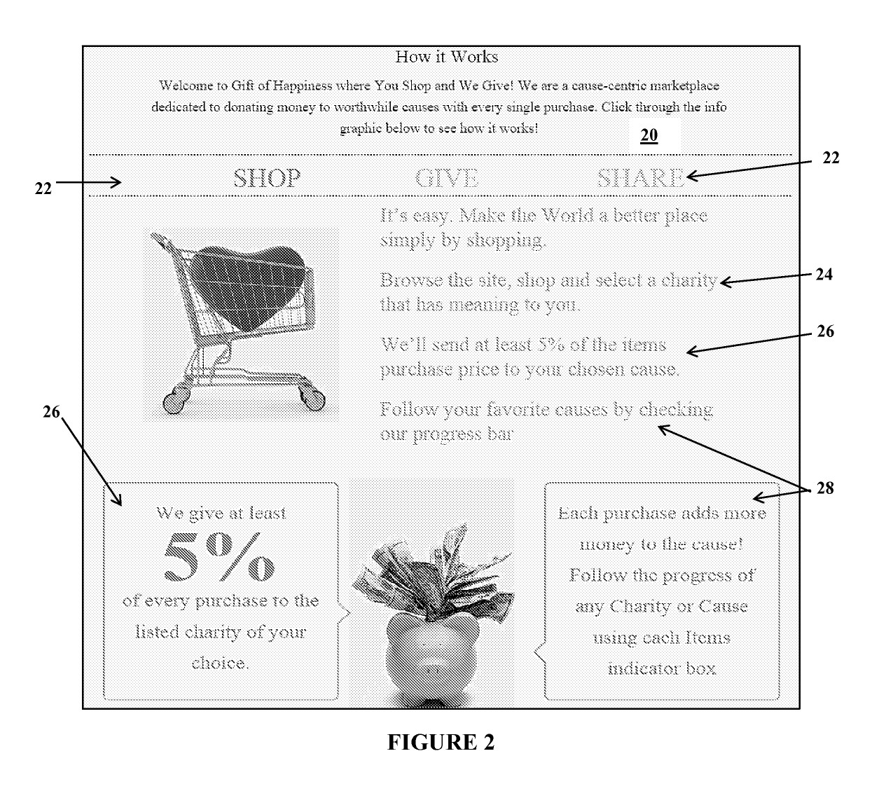

As shown in the captured screenshots of FIGS. 2 through 4, The present invention utilizes a website for allowing a consumer to make donations to pre-suggested third-party beneficiaries or those designated by the consumer on a prospective basis on the basis of a consumer purchase made available from an authorized merchants. One or multiple third-party beneficiaries are provided to participating users during the on-line purchasing process. Some suggested amount or consumer selected amount both of which may be expressed as a percentage or dollar amount of the purchase amount of the purchased item is awarded to one or more third party beneficiaries on a product-by-product or entire order basis designated by the purchaser who wishes to participate in the third-party beneficiary donation system.

Referring once again to FIGS. 2 through 4, there shown a captured website screenshots that depicts a customers' ability to choose either one or more third party beneficiaries. Turning to FIG. 2, there is illustrated a captured website screenshot 20 of a “how it works” page that instructs the consumer to understand their donation (the share icon 22), that they may browse charities to assist in making a choice 24, the fixed amount of donation that is recommended 26 and a motivation tag 28 to inspire a consumer to donate.

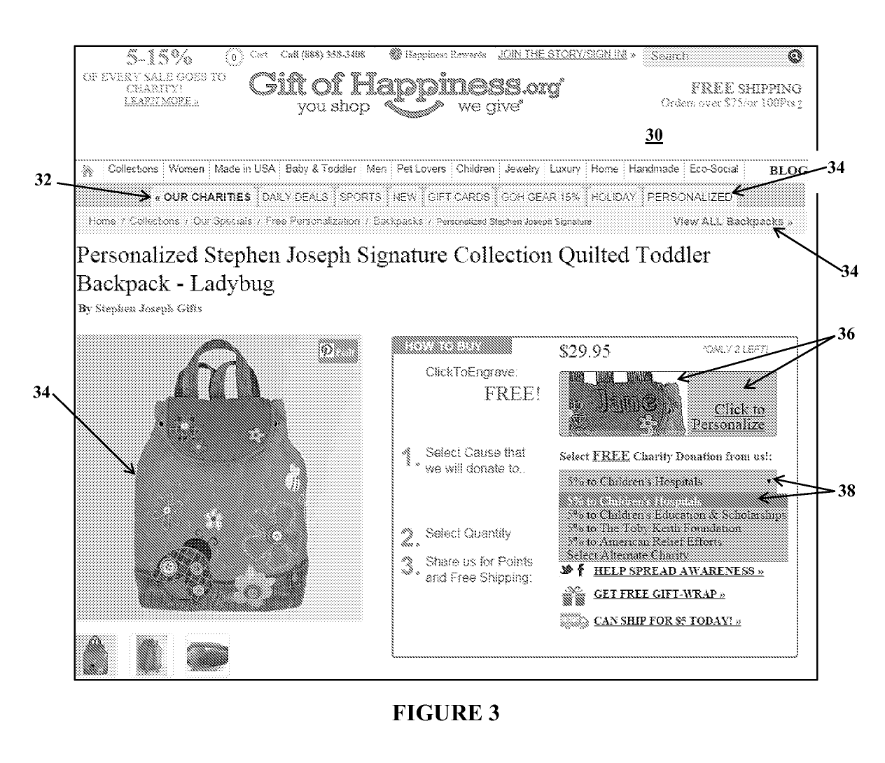

Referring now to FIG. 3, there is shown a captured website screenshot 30 that depicts a consumers ability to choose an item 34 in association with a charity 32. As depicted in FIG. 3, the item may be personalized 34 with a name or word 36 wherein the merchant may offer a charitable donation (as illustrated in the picture box 38) to encourage the consumer to buy the item.

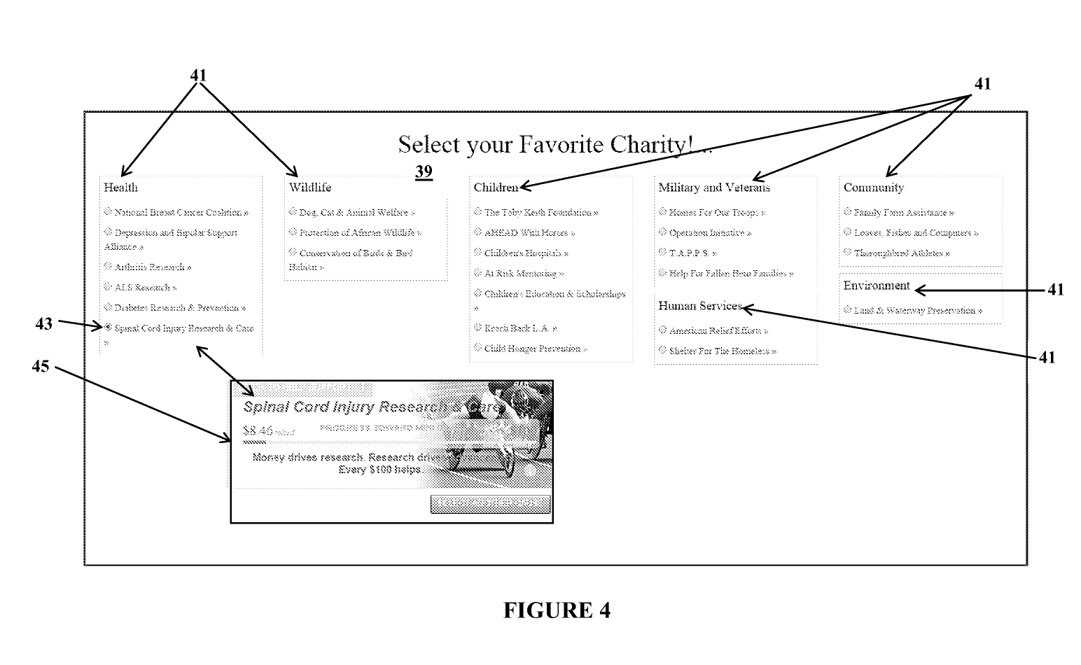

Additionally, as shown in FIG. 4, there is shown a captured website screenshot 39 that depicts for the consumer the different charities and causes 41 by category that are offered by the merchant. Furthermore, the consumer may select a charity 43 for a given category and view details of that charity 45 to view a description from the chosen charity to better let the consumer understand what their donation will be used for by the given charity.

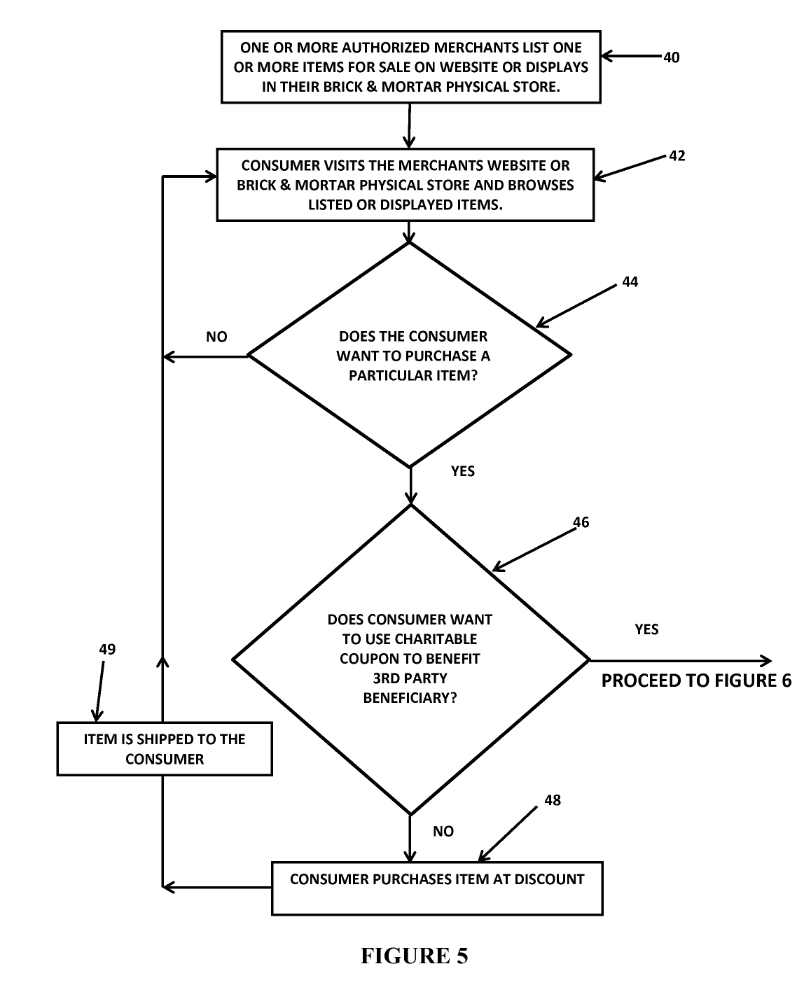

Referring now to FIG. 5, there is shown a flowchart illustrating an example of one method for making donations to third party beneficiaries in accordance with the present invention present invention. As shown in FIG. 5, step 40 is where one or more authorized merchants first list their one or more items for sale using an automated, network based software program which may be deployed as a website or displays in brick & mortar physical stores. Next in step 42, a consumer visits this website and browses one or more of these listed items. The consumer now chooses 44 whether to purchase a particular item for sale. If not the consumer continues browsing items 42 or may come back to visit the website at another time to browse again. However, if the consumer chooses to make a purchase they now have a choice whether or not to use a charitable coupon (if they have one) to benefit a 3^{rd} Party Beneficiary as shown in step 46. If the consumer does not want additional monies donated, the consumer purchases the item at a discount wherein the purchased item is either shipped to the consumer or the consumer departs the physical store with the item as shown in steps 48 and 49 wherein the consumer is returned to step 42 to browse again.

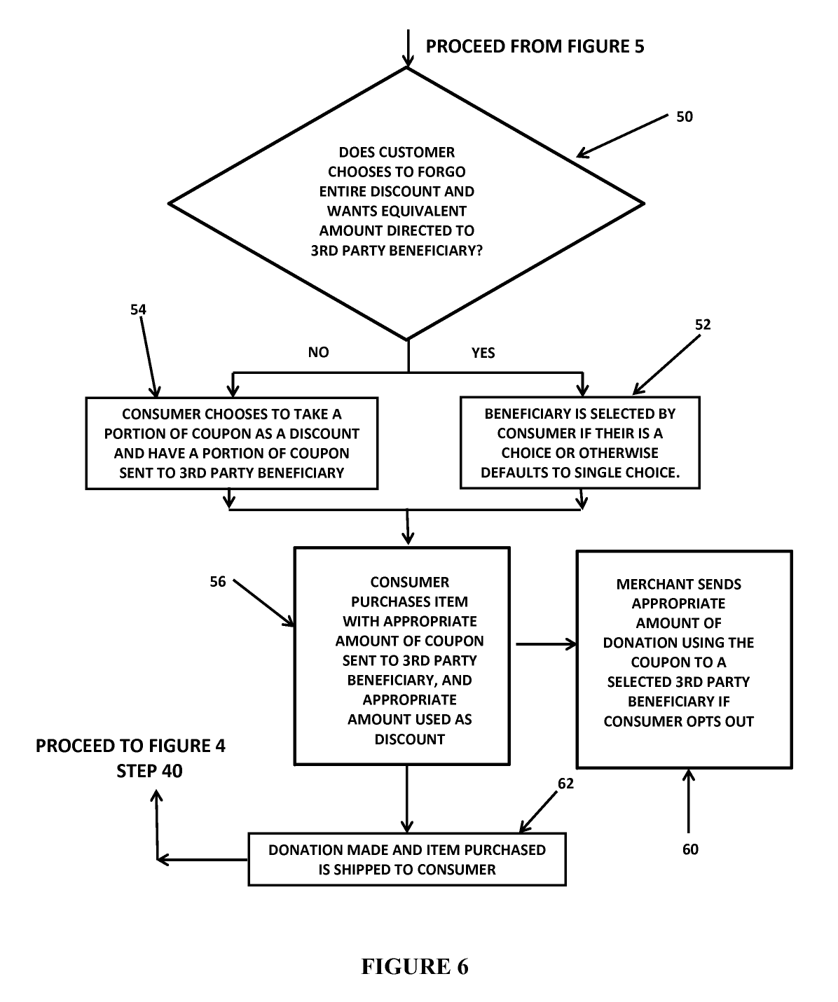

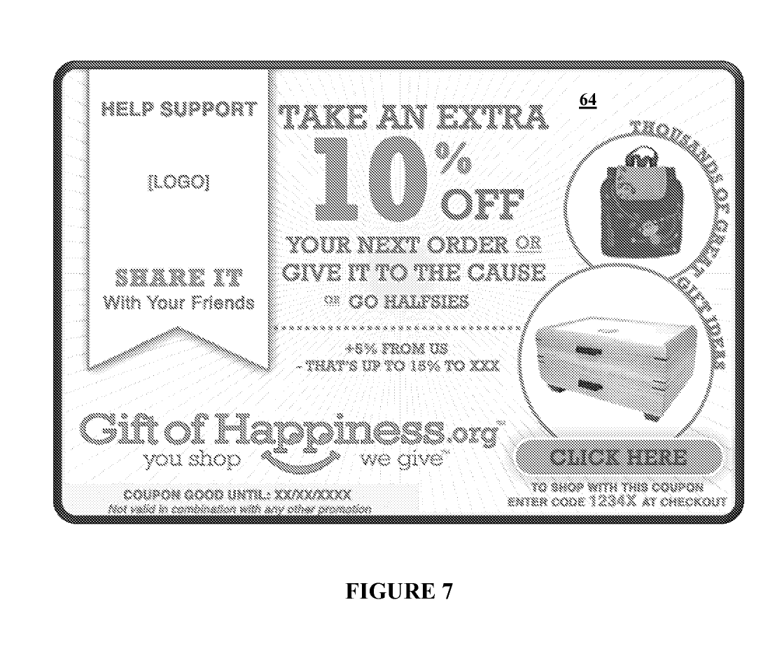

Referring now to FIG. 6, there is shown a flowchart that is a continuation from FIG. 5. Beginning at step 50 if the customer or consumer chooses to forgo the entire discount and wants an equivalent amount directed to 3rd party beneficiary the beneficiary is selected by the consumer if there is a choice or otherwise defaults to a single choice as shown in step 54. If not, the consumer chooses to take a portion of the coupon as a discount and have a portion of the coupon sent to the 3rd party beneficiary in step 52. Next, the consumer may also purchase an item using a previously sent or mailed coupon for determining a donation amount based on the purchased items which is sent to the 3rd party beneficiary as shown in step 56. In this step 62, the item is purchased and sent to the consumer wherein the process starts again at step 40 in FIG. 5. One example of such a coupon 64 is shown in FIG. 7. However, if the consumer opts out of this decision, the merchant in step 60 uses an advertised standard fixed percentage as announced on a website or brick and mortar store for sending the donation to the selected third party beneficiary selected. The purchased items either shipped to the consumer or the consumer departs the physical store with the item(s) ending the transaction in step 62.

Turning once again to FIG. 7, there is illustrated a web-based or physical coupon 64 methodology which allows a purchaser to select from the following steps a) take the full amount of the coupon as a discount to purchase price or b) forgo the personal discount benefit entirely and assert a directive that the equivalent amount go to the third party beneficiary(s) or c) the consumer can choose to take a portion of the coupon value as a discount to purchase price and issue a directive for the other portion be given to a third party beneficiary(s). Therefore, FIG. 7 depicts one example of a typical discount that may be delivered either physically (in the form of paper or other material) or electronically (via email, worldwide web or other electronic mediums).

In summary, a manual and/or automated, network based, third-party beneficiary donation method and system that allows a merchant to provide a choice to participating consumer(s) in the form of donations to third party beneficiaries based on consumer purchases has been described. It should be understood that the consumer chooses their third party beneficiary from a merchant curated list or customer self-generated list and independently determines the percentage amount of the donation or selects a pre-determined amount. In this manner, consumers are provided with an option to purchase products from the merchant knowing that the product purchases may result in a specified donation to a consumer selected third-party beneficiary or multiple selected third party beneficiaries on a per product or per order basis. Third party beneficiaries are generally intended to be charities or causes (herein used synonymously) but are not required to have tax-exempt status.

Furthermore, a donation platform is provided that attaches amounts of charitable donations linked to discounts of the products being purchased. This is unique from traditional coupons that one dimensionally discounts the purchase price of a product to the consumer. Additionally, the use of a coupon with the donation platform enables a consumer to have multiple choices in regards to the use of a coupon. The consumer may either take a full amount of the coupon as a discount to purchase price or forgo the personal discount benefit entirely and assert a directive to the authorized merchant to give the equivalent amount to one or more charities or causes of the consumers or authorized merchants choice as a donation or monetary support, or the consumer may choose to take a portion of the coupon value as a discount to purchase price and issue a directive for the other portion be given to one or more customer selected charities or causes.

It should be understood that any of the embodiments described with FIGS. 1 thru 4 may be transacted at a physical brick and mortar store or be performed by computers, including general purpose computers, connected (to a network or the Internet) computers, or combinations of client-server computers and/or peer-to-peer terminals. In one embodiment, for example, network is provided on a server, and accessed by a user through a web interface. However, alternatives are possible, including use of standalone computers to provide network. In accordance with one deployment, the network may be provisioned as software executing on a server in the cloud. Client device such as mobile phones are provisioned with a client application to connect with the over a network (e.g. the Internet).

It is contemplated for embodiments of the invention to extend to individual elements and concepts described herein, independently of other concepts, ideas or system, as well as for embodiments to include combinations of elements recited anywhere in this application. Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. This, the absence of describing combinations should not preclude the inventor from claiming rights to such combinations.

In general, the routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, USB and other removable media, hard disk drives, optical disks (e.g., Compact Disk Read-Only Memory (CD ROMS), Digital Versatile Disks, (DVDs), etc.), and flash drives, among others.

Although the present invention has been described with reference to specific exemplary embodiments, it will be evident that the various modification and changes can be made to these embodiments without departing from the broader spirit of the invention. Accordingly, the specification and drawings are to be regarded in an illustrative sense rather than in a restrictive sense.

What is claimed is:

1. A method for donating to third-party beneficiaries, comprising:
listing one or more items for sale by one or more authorized merchants through an automated, network based software program;
choosing by a consumer which said one or more items are to be purchased;
providing one or more third party beneficiaries for which a donation is to be made;
selecting by said consumer which third party beneficiary will receive said donation;
calculating an amount of said donation based on said one or more items purchased; and
donating said amount from said consumer purchase to said selected third party beneficiary using said automated, network based software program.

2. The method according to claim 1 wherein said donation is a fixed amount selected by said consumer.

3. The method according to claim 1 wherein said donation is a percentage amount determined by said one or more purchased items.

4. The method according to claim 1 wherein the step of providing one or more said third party beneficiaries is from a merchant curated list.

5. The method according to claim 1 further comprising a step of providing said consumer an option to purchase said items knowing that said purchases will result in a specified donation to a customer selected single third-party beneficiary on a per item basis.

6. The method according to claim 1 further comprising a step of providing said consumer an option to purchase said items knowing that said purchases will result in a specified donation to a customer selected single third-party beneficiary on a per order basis.

7. The method according to claim 1 further comprising a step of providing said consumer an option to purchase said items knowing that said purchases will result in a specified donation to a customer selected multiple third-party beneficiaries on a per item basis.

8. The method according to claim 1 further comprising a step of providing said consumer an option to purchase said items knowing that said purchases will result in a specified donation to a customer selected multiple third-party beneficiaries on a per order basis.

9. The method according to claim 1 further comprising a step of providing said consumer an option to purchase said items knowing that said purchases will result in a specified donation to a merchant selected single third-party beneficiary on a per item basis.

10. The method according to claim 1 further comprising a step of providing said consumer an option to purchase said items knowing that said purchases will result in a specified donation to a merchant selected single third-party beneficiary on a per order basis.

11. The method according to claim 1 further comprising a step of providing said consumer an option to purchase said items knowing that said purchases will result in a specified donation to a merchant selected multiple third-party beneficiaries on a per item basis.

12. The method according to claim 1 further comprising a step of providing said consumer an option to purchase said items knowing that said purchases will result in a specified donation to a merchant selected multiple third-party beneficiaries on a per order basis.

13. The method according to claim 1 wherein said third party beneficiaries are tax-exempt charities

14. The method according to claim 1 wherein said third party beneficiaries are causes.

15. The method according to claim 1 further comprising the step of delivering to said consumer a charitable coupon for use in donating a predetermined percentage of said purchase amount of said consumer selected item to said one or more said third party beneficiaries.

16. A method for donating to third-party beneficiaries, comprising:
displaying one or more items for sale by one or more authorized merchants at their brick and motor operation;
choosing by a consumer which said one or more items are to be purchased;
providing one or more third party beneficiaries for which a donation is to be made;
selecting by said consumer which third party beneficiary will receive said donation;
calculating an amount for said donation based on said one or more items purchased; and
donating said amount of said consumer purchase to said selected third party beneficiary.
